(19) United States
(12) Patent Application Publication
(10) Pub. No.: US 2024/0265231 A1
(43) Pub. Date: Aug. 8, 2024

(54) RESERVOIR COMPUTER AND EQUIPMENT STATE DETECTION SYSTEM

(71) Applicant: HITACHI, LTD., Tokyo (JP)

(72) Inventors: Takashi OSHIMA, Tokyo (JP); Goichi Ono, Tokyo (JP); Akira Kitayama, Tokyo (JP); Keita Yamane, Tokyo (JP)

(21) Appl. No.: 18/510,993

(22) Filed: Nov. 16, 2023

(30) Foreign Application Priority Data
Feb. 2, 2023 (JP) 2023-014656

(51) Int. Cl. G06N 3/04

(52) U.S. Cl. CPC G06N 3/04

(57) ABSTRACT

A reservoir computer based on an echo state network is efficiently implemented on hardware, and a trade-off relationship between a total number of neurons that can be implemented and a processing speed can be eliminated. A reservoir layer of the reservoir computer is divided into a plurality of sub-reservoirs, each of the sub-reservoirs includes a plurality of reservoir neurons, each of the reservoir neurons includes a selector, a multiplier, an integrator, and an activation function calculator that are arranged in this order. According to a selection signal, the selector sequentially selects one of a reservoir input signal and output signals from the reservoir neurons each of which is multiplied by a non-zero weight in the multiplier.

### BACKGROUND OF THE INVENTION

### 1. Field of the Invention

The present invention relates to a reservoir computer and an equipment state detection system.

### 2. Description of Related Art

In order to maintain and manage equipment such as social infrastructure and a large industrial machine, an equipment state detection system capable of detecting an abnormal state of the equipment by analyzing a time-series signal output from a sensor (for example, a vibration sensor) disposed in the equipment or in the vicinity of the equipment is desired to be put into use.

In order to establish an algorithm for analyzing the time-series signal, it is required to learn the time-series signal in advance. In relation to the learning, for example, a method using deep learning such as a recurrent neural network (RNN) or a long short-term memory (LTSM) or a method using reservoir computing is known.

In general, learning is not easy in the method using deep learning, and requires much time and labor. The time-series signal can be easily learned using the method using reservoir computing as compared with the method using deep learning. In particular, reservoir computing based on an echo state network has accumulated studies and is a standard model for the reservoir computing.

In relation to a technique of implementing a computer on hardware, for example, PTL 1 describes a tri-state neural network circuit 200 including, in an intermediate layer, an input value Xi to which convolution is applied, a non-zero convolution calculation circuit 21 configured to receive a weight Wi and perform a convolution calculation, a sum circuit 22 configured to take a sum of a bias W0 and each calculation value subjected to the convolution calculation, and an activation function circuit 23 configured to convert, using an activation function f(u), a signal Y generated by taking the sum. The non-zero convolution calculation circuit 21 skips a weight for which the weight Wi is zero and performs a convolution calculation based on a non-zero weight and the input value Xi corresponding to the non-zero weight.

### CITATION LIST

### Patent Literature

PTL 1: JP2019-200553A

### SUMMARY OF THE INVENTION

In a reservoir computer based on an echo state network, it is required that neurons are randomly and sparsely coupled. Therefore, it is difficult to efficiently implement the reservoir computer on hardware. As a result, there is a trade-off relationship between the total number of neurons and a processing speed in the reservoir computer based on an echo state network, and thus it is difficult to detect a minor abnormality when the reservoir computer is used in an equipment state detection system.

Although PTL 1 discloses that a zero weight calculation is omitted (hereinafter, referred to as zero skip) in a convolution deep neural network, since a configuration, an operation, and a purpose are different from those of a reservoir computer using an echo state network according to the invention, it is not easy to apply the zero skip described in PTL 1 to the echo state network.

The invention has been made in view of the above points, and an object of the invention is to enable a reservoir computer based on an echo state network to be efficiently implemented on hardware.

The present application includes a plurality of means for solving at least a part of the above problems, and examples thereof are as follows.

In order to solve the above problem, a reservoir computer according to one aspect of the invention is a reservoir computer based on an echo state network. The reservoir computer includes a reservoir layer configured to receive a time-series signal as a reservoir input signal, and a read layer, the reservoir layer is divided into a plurality of sub-reservoirs, each of the sub-reservoirs includes a plurality of reservoir neurons, each of the reservoir neurons includes the following units arranged in this order: a selector configured to sequentially select one of the reservoir input signal and output signals from the plurality of reservoir neurons, a multiplier configured to multiply a selection result of the selector by a weight, an integrator configured to integrate multiplication results of the multiplier, and an activation function calculator configured to calculate an output value of an activation function in which an integration result of the integrator is set as an input, the selector sequentially selects, according to a selection signal, one of the reservoir input signal and the output signals from the reservoir neurons each of which is multiplied by a non-zero weight in the multiplier, and the read layer performs a product-sum calculation using a read weight on the output signals from the plurality of reservoir neurons included in each of the plurality of sub-reservoirs, and outputs a calculation result as an output signal from the reservoir computer.

According to the invention, a reservoir computer based on an echo state network can be efficiently implemented on hardware, and a trade-off relationship between a total number of neurons that can be implemented and a processing speed can be eliminated.

Problems, configurations, and effects other than those described above will become apparent in the following description of embodiments.

### BRIEF DESCRIPTION OF THE DRAWINGS

FIG. 1 is a diagram showing a configuration example of a reservoir computer according to a first embodiment of the invention;

FIG. 2 is a diagram showing a first configuration example of a sub-reservoir;

FIG. 3A and FIG. 3B are diagrams showing a difference between a case where zero skip is performed and a case where zero skip is not performed in the sub-reservoir, FIG. 3A is a diagram showing a time chart in the case where the zero skip is performed, and FIG. 3B is a diagram showing a time chart in the case where the zero skip is not performed;

FIG. 4 is a diagram showing a second configuration example of the sub-reservoir;

FIG. 5 is a diagram showing an example of values of selection signals and weights stored in a weight storage division memory;

FIG. 6 is a diagram showing a configuration example of a reservoir computer according to a second embodiment of the invention;

FIG. 7 is a diagram showing an example of a processing period in a sub-reservoir;

FIG. 8 is a diagram showing an example of characteristics of a variable band filter;

FIG. 9 is a diagram showing a configuration example of a reservoir computer according to a third embodiment of the invention;

FIG. 10A and FIG. 10B are diagrams showing zero weight ratio search processing, FIG. 10A is a flowchart showing an example of the zero weight ratio search processing, and FIG. 10B is a timing chart showing an example of the zero weight ratio search processing;

FIG. 11 is a diagram showing a configuration example of a reservoir computer according to a fourth embodiment of the invention;

FIG. 12 is a diagram showing an operation of a selector using an FPGA; and

FIG. 13A and FIG. 13B are diagrams showing a configuration example of the selector using the FPGA, FIG. 13A is a diagram showing a configuration example of a 6-input look up table (LUT), and FIG. 13B is a diagram showing a configuration example of a Block RAM (BRAM).

### DESCRIPTION OF EMBODIMENTS

Hereinafter, a plurality of embodiments of the invention will be described with reference to the drawings. The embodiments are examples illustrating the invention, and are appropriately omitted and simplified for the clarity of description. The invention can be implemented in various other forms. Unless otherwise specified, each component may be single form or plural form. A position, a size, a shape, a range, and the like of each component shown in the drawings may not represent an actual position, size, shape, range, and the like for easy understanding of the invention. Therefore, the invention is not necessarily limited to a position, a size, a shape, a range, and the like disclosed in the drawings. As examples of various kinds of information, expressions such as “table”, “list”, and “queue” may be used to describe the various kinds of information, and the various kinds of information may be expressed by a data structure other than those expressions. For example, various kinds of information such as “XX table”, “XX list”, and “XX queue” may be “XX information”. Expressions such as “identification information”, “identifier”, “name”, “ID”, and “number” are used to describe identification information, and these expressions can be replaced with one another. In all the drawings illustrating the embodiments, the same members are denoted by the same reference numerals in principle, and repeated description thereof is omitted. In the following embodiments, components (including element steps and the like) are not necessarily essential unless otherwise specified or unless clearly considered to be essential in principle. When expressions such as “configured with A”, “constituting of A”, “having A”, and “including A” are used, other elements are not excluded unless otherwise specified that only an element is included. Similarly, in the following embodiments, when a shape, a positional relationship, or the like of a component or the like is mentioned, the shape, the positional relationship, or the like of the component substantially includes those that are approximate or similar to the shape or the like unless otherwise specified or unless clearly considered to be otherwise in principle.

### Configuration Example of Reservoir Computer 10₁ According to First Embodiment of Invention

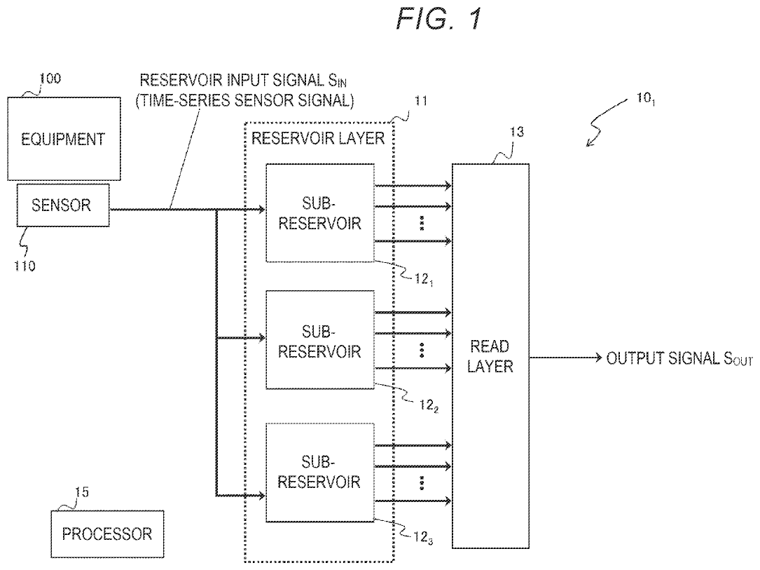

FIG. 1 shows a configuration example of a reservoir computer 10₁ based on an echo state network according to a first embodiment of the invention.

The reservoir computer 10₁ is employed in a state detection system that detects a minor abnormal state in a stage before an abnormality occurs in the appearance of equipment 100. The equipment 100 may include, for example, social infrastructure such as a water and sewage pipe, a bridge, a road, and the like, and a large industrial machine including an engine, a motor, and the like.

The reservoir computer 10₁ receives a time-series sensor signal from a sensor 110 disposed in the equipment 100 or in the vicinity of the equipment 100 as a reservoir input signal S_{IN}. In the present embodiment, the time-series sensor signal is a digital signal. A case where the time-series sensor signal is an analog signal will be described later. The reservoir computer 10₁ outputs a detection result of an abnormal state as an output signal Sour. The output signal S_{OUT} may be, for example, a binary signal indicating the presence or absence of an abnormality or a signal indicating an abnormal state in more details. The sensor 110 includes, for example, a vibration sensor, a sound sensor, and a temperature sensor.

The reservoir computer 10₁ includes a reservoir layer 11, a read layer 13, and a processor 15. The reservoir layer 11, the read layer 13, and the processor 15 are implemented on hardware such as a field programmable gate array (FPGA).

A time-series sensor signal from the sensor 110 is input to the reservoir layer 11 as the reservoir input signal S_{IN}. The reservoir layer 11 is divided into a plurality of (three in the case of FIG. 1) sub-reservoirs 12₁, 12₂, and 12₃. Hereinafter, the sub-reservoirs 12₁, 12₂, and 12₃ are referred to as a sub-reservoir 12 when it is not necessary to distinguish the sub-reservoirs 12₁, 12₂, and 12₃ from one another. The number at which the reservoir layer 11 is divided into the sub-reservoirs 12 is not limited to three, and may be two or four or more.

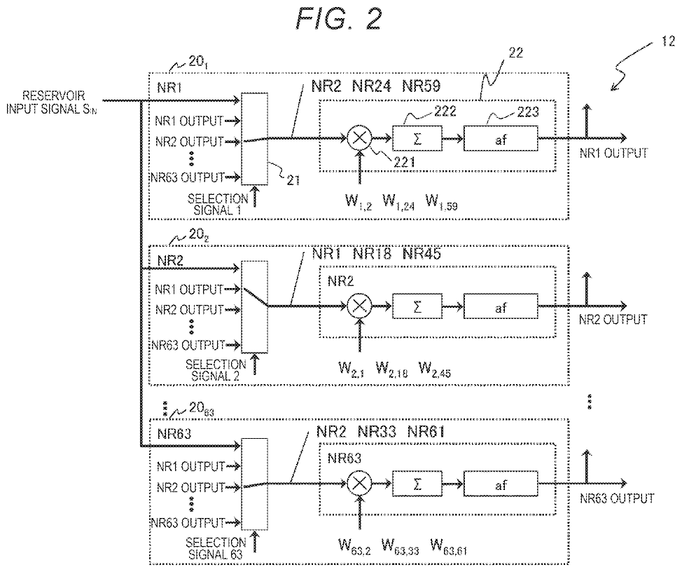

The sub-reservoir 12 is a zero skip sub-reservoir that performs zero skip to omit calculation when a weight W is zero. The sub-reservoir 12 includes a plurality of reservoir neurons (details will be described later), and outputs output signals NR from the plurality of reservoir neurons 20 (FIG. 2) to the read layer 13 in a subsequent stage.

The read layer 13 performs, using a read weight, a product-sum calculation on the output signals NR from the plurality of reservoir neurons 20 received from the sub-reservoir 12, and outputs a result as the output signal Sour of the reservoir computer 10₁. At least one of the reservoir input signal S_{IN} and the output signal S_{OUT} may be a plurality of signals.

The processor 15 includes, for example, a CPU and controls the entire reservoir computer 10₁.

### First Configuration Example of Sub-Reservoir 12

Next, FIG. 2 shows a first configuration example of the sub-reservoir 12. The first configuration example of the sub-reservoir 12 includes a plurality of (63 in FIG. 2) reservoir neurons 20₁ to 20₆₃. Hereinafter, output signals of the reservoir neurons 20₁, 20₂, . . . 20₆₃ are referred to as output signals NR1, NR2, . . . NR63. The reservoir neurons 20₁ to 20₆₃ are referred to as reservoir neurons 20 and the output signals NR1 to NR63 are referred to as output signals NR when it is not necessary to distinguish the reservoir neurons 20₁ to 20₆₃ from one another and the output signals NR1 to NR63 from one another.

Each of the reservoir neurons 20 includes a selector 21 and a reservoir neuron unit 22. The selector 21 receives, as inputs, the reservoir input signal S_{IN} and the output signals NR of all the reservoir neurons 20 constituting the same sub-reservoir 12.

The selector 21 sequentially selects one of the input signals according to a selection signal from the processor 15 and outputs the selected signal to the reservoir neuron unit 22. Specifically, the selector 21 first selects the reservoir input signal S_{IN} and outputs the selected reservoir input signal S_{IN} to the reservoir neuron unit 22. Next, among the output signals NR of all of the reservoir neurons 20, the selector 21 sequentially selects only a signal for which a weight W_{j,k} (j=1, 2, . . . 63, and k=1, 2, . . . 63) multiplied by a multiplier 221 in the reservoir neuron unit 22 in a subsequent stage is not zero, and outputs the selected signal to the reservoir neuron unit 22. The numbers of the non-zero weights W_{j,k} supplied to the respective reservoir neurons 20 constituting the sub-reservoir 12 are unified.

The reservoir neuron unit 22 includes the multiplier 221, an integrator 222, and an activation function calculator (af) 223 in this order. The multiplier 221 multiplies the reservoir input signal S_{IN} received from the selector 21 by a weight W_{j,0} supplied from the processor 15, and outputs a multiplication result to the integrator 222. The multiplier 221 multiplies the output signals NR from the reservoir neurons 20 sequentially received from the selector 21 by the non-zero weights W_{j,k} supplied from the processor 15, and outputs multiplication results to the integrator 222. The integrator 222 integrates the multiplication results sequentially received from the multiplier 221, and outputs an integration result to the activation function calculator 223. The activation function calculator 223 calculates an output value of an activation function in which the integration result received from the integrator 222 is set as an input, and outputs the output value as output signals NR of the reservoir neurons 20 to a subsequent stage.

For example, in the case of the reservoir neuron 20₁ shown in FIG. 2, the selector 21 first selects the reservoir input signal S_{IN} according to a selection signal 1 and outputs the selected reservoir input signal S_{IN} to the reservoir neuron unit 22. Next, the selector 21 sequentially selects the output signals NR2, NR24, and NR59 of the reservoir neurons 20 to be respectively multiplied by W_{1,2}, W_{1,24}, and W_{1,59} for which the weight W_{j,k} of a product-sum calculation in the reservoir neuron unit 22 is not zero, and outputs the selected signals to the reservoir neuron unit 22.

Then, the reservoir neuron unit 22 of the reservoir neuron 20₁ calculates an output value of an activation function in which W_{1,0}·S_{IN}+W_{1,2}·NR2+W_{1,24}·NR24+W_{1,59}·NR59, which is a result of the product-sum calculation, is set as an input, and outputs the output value as the output signal NR1 of the reservoir neuron 20₁ to a subsequent stage. Product-sum processing on the reservoir input signal S_{IN} may be performed at a timing or using a method other than those described above.

For example, in the case of the reservoir neuron 20₂ shown in FIG. 2, the selector 21 first selects the reservoir input signal S_{IN} according to a selection signal 2 and outputs the selected reservoir input signal S_{IN} to the reservoir neuron unit 22. Next, the selector 21 sequentially selects the output signals NR1, NR18, and NR45 of the reservoir neurons 20 to be respectively multiplied by W_{2,1}, W_{2,18}, W_{2,45} for which the weight W_{j,k} of a product-sum calculation in the reservoir neuron unit 22 is not zero, and outputs the selected signals to the reservoir neuron unit 22.

Then, the reservoir neuron unit 22 of the reservoir neuron 20₂ calculates an output value of an activation function in which W_{2,0}·S_{IN}+W_{2,1}·NR1+W_{2,18}·NR18+W_{2,45}·NR45, which is a result of the product-sum calculation, is set as an input, and outputs the output value as the output signal NR2 of the reservoir neuron 20₂ to a subsequent stage. The product-sum processing on the reservoir input signal S_{IN} may be performed at a timing or using a method other than those described above.

The same calculation is performed in the reservoir neurons 20₃ to 20₆₃. Accordingly, 63 output signals NR1 to NR63 are input from each of the three sub-reservoirs 12₁ to 12₃ to the read layer 13.

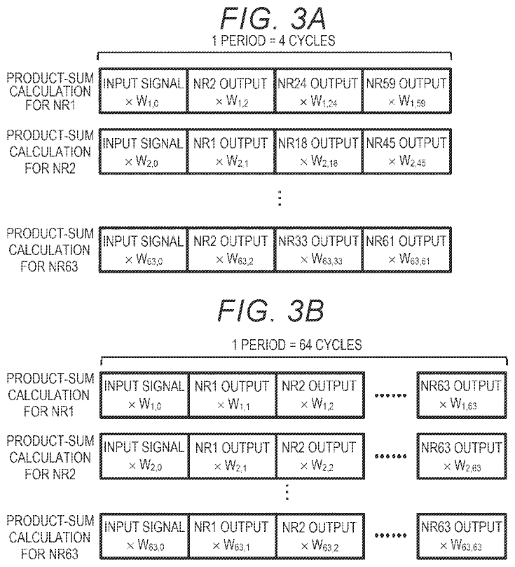

Next, a difference between a case where zero skip is performed and a case where zero skip is not performed in the sub-reservoir 12 will be described. FIG. 3A shows a time chart in a case where zero skip is performed in the sub-reservoir 12. FIG. 3B shows a time chart in a case where zero skip is not performed in the sub-reservoir 12.

For example, when a product-sum calculation is performed on a total of four signals including the reservoir input signal S_{IN} and the three output signals NR in each of the reservoir neurons 20 (NR1 to NR63) as in the sub-reservoir 12 shown in FIG. 2, one period in which each reservoir neuron 20 outputs the output signals NR once includes four cycles as shown in FIG. 3A.

On the other hand, when zero skip is not performed in the sub-reservoir 12, as shown in FIG. 3B, a product-sum calculation is performed on a total of 64 input signals including the reservoir input signal S_{IN} and the 63 output signals NR in each of the reservoir neurons 20 (NR1 to NR63). Accordingly, one period in which each reservoir neuron 20 outputs the output signals NR once includes 64 cycles.

Accordingly, a processing speed required in the product-sum calculation in the case where the zero skip is performed as in the present embodiment (FIG. 3A) can be increased to 16 times a processing speed in the case where the zero skip is not performed (FIG. 3B).

In the present embodiment, the reservoir layer 11 is divided into a plurality of sub-reservoirs 12, and the product-sum calculation is performed only by the reservoir neurons 20 in the same sub-reservoir 12. Accordingly, a target of the product-sum calculation is limited to only the output signals NR of the 63 reservoir neurons 20 included in the same sub-reservoir 12. In an actual product-sum calculation, the targets are limited to those having a non-zero weight W_{j,k} among the output signals NR of the 63 reservoir neurons 20. As described above, since the number of input signals for performing the product-sum calculation is limited to two in the present embodiment, the number of times of the product-sum calculation can be significantly reduced, and as a result, the number of cycles required to complete the product-sum calculation can be significantly reduced. Therefore, the reservoir computer 10₁ can be efficiently implemented on hardware, and a trade-off relationship between a total number of neurons that can be implemented and a processing speed can be eliminated.

A limited product-sum calculation may be added between different sub-reservoirs 12 (for example, between the sub-reservoir 12₁ and the sub-reservoir 12₂) as needed. If the product-sum calculation is limited, the sub-reservoir 12 can be implemented without decreasing a processing speed.

As described above, according to the reservoir computer 10₁, a processing speed (that is, in the case of the present embodiment, a frequency of processing the received reservoir input signal S_{IN}) can be significantly improved as compared with a reservoir computer in the related art in which zero skip is not performed. Accordingly, it is possible to process a time-series sensor signal as the reservoir input signal S_{IN} up to a high-frequency component, and as a result, it is possible to detect a state of the equipment 100 provided with the sensor 110 with high sensitivity.

### Second Configuration Example of Sub-Reservoir 12>

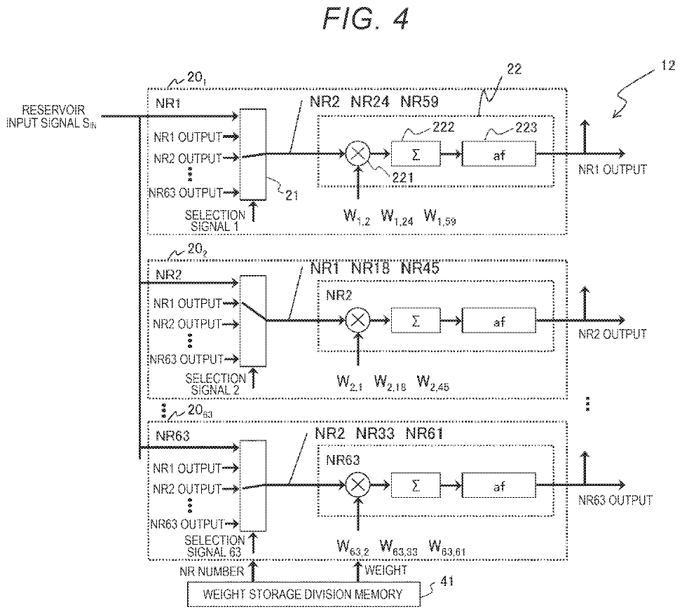

Next, FIG. 4 shows a second configuration example of the sub-reservoir 12. The second configuration example of the sub-reservoir 12 is obtained by adding a weight storage division memory 41 to the first configuration example (FIG. 2). Among components in the second configuration example, components other than the weight storage division memory 41 are common to the components in the first configuration example, the common components are denoted by the same reference numerals, and description thereof will be omitted.

The weight storage division memory 41 stores, in advance, a selection number serving as a selection signal for the selector 21 of the reservoir neuron 20 and the weight W_{j,k} for the multiplier 221. The selection number and the weight W_{j,k} stored in the weight storage division memory 41 are read by, for example, the processor 15 and supplied to the selector 21 and the multiplier 221 of the reservoir neuron 20.

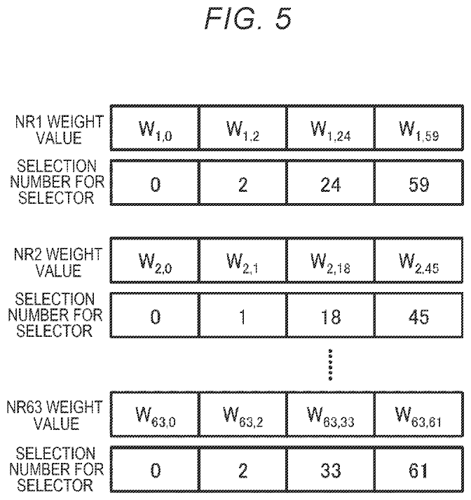

FIG. 5 shows an example of the selection numbers and the weight W_{j,k} stored in the weight storage division memory 41. The weight storage division memory 41 is divided into 63 areas corresponding to the reservoir neurons 20₁ to 20₆₃, and the non-zero weights W_{j,k} for performing the product-sum calculation in the reservoir neuron 20 and the selection numbers for the selector 21 are stored in each of the areas in order.

For example, in an area of the weight storage division memory 41 corresponding to the reservoir neuron 20₁ (NR1), the selection number 0 for the selector 21 to select the reservoir input signal S_{IN} and a weight W_{1,0} are stored at a first position. A selection number 2 for the selector 21 to select the output signal NR2 and a non-zero weight W_{1,2} are stored at a second position. A selection number 24 for the selector 21 to select the output signal NR24 and a non-zero weight W_{1,24} are stored at a third position. A selection number 59 for the selector 21 to select the output signal NR59 and a non-zero weight W_{1,59} are stored at a fourth position.

For example, in an area of the weight storage division memory 41 corresponding to the reservoir neuron 20₂ (NR2), the selection number 0 for the selector 21 to select the reservoir input signal S_{IN} and a weight W_{2,0} are stored at a first position. A selection number 1 for the selector 21 to select the output signal NR1 and a non-zero weight W_{2,1} are stored at a second position. A selection number 18 for the selector 21 to select the output signal NR18 and a non-zero weight W_{2,18} are stored at a third position. A selection number 45 for the selector 21 to select the output signal NR45 and a non-zero weight W_{2,45} are stored at a fourth position.

Similarly, in areas of the weight storage division memory 41 corresponding to the reservoir neurons 20₃ (NR3) to 20₆₃ (NR63), the selection numbers for the selector 21 and the weights W_{j,k} are stored in order from the first position to the fourth position.

According to the second configuration example of the sub-reservoir 12, input signals and weights W_{j,k} required in the calculation of one cycle shown in FIG. 3A can be simultaneously and seamlessly read and multiplication of each cycle can be seamlessly performed, by providing the weight storage division memory 41. Therefore, a period of one cycle can be shortened, and a processing speed can be further increased as compared with the first configuration example.

### Configuration Example of Reservoir Computer 10₂ According to Second Embodiment of Invention

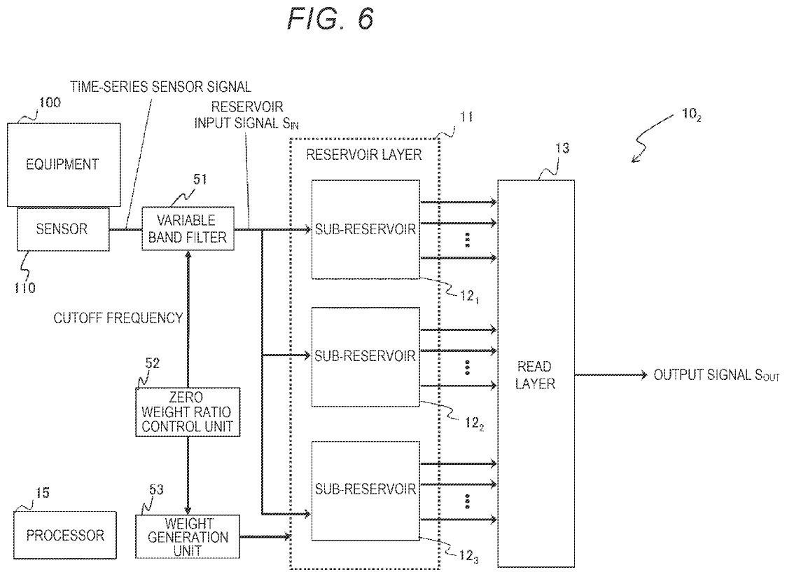

FIG. 6 shows a configuration example of a reservoir computer 10₂ based on an echo state network according to a second embodiment of the invention.

The reservoir computer 10₂ is obtained by adding a variable band filter 51, a zero weight ratio control unit 52, and a weight generation unit 53 to the reservoir computer 10₁ (FIG. 1). Components of the reservoir computer 10₂ other than the variable band filter 51, the zero weight ratio control unit 52, and the weight generation unit 53 are common to components of the reservoir computer 10₁, the common components are denoted by the same reference numerals, and description thereof will be omitted. The reservoir layer 11 in the reservoir computer 10₂ employs the second configuration example (FIG. 4) having the weight storage division memory 41.

The variable band filter 51 is provided in a stage before the reservoir layer 11. The variable band filter 51 limits a band of a time-series sensor signal according to a cutoff frequency on a high-frequency side designated by the zero weight ratio control unit 52. The band-limited time-series sensor signal is input to the reservoir layer 11 as the reservoir input signal S_{IN}.

The zero weight ratio control unit 52 is implemented by, for example, the processor 15. The zero weight ratio control unit 52 sets the cutoff frequency on the high-frequency side in the variable band filter 51 and outputs the cutoff frequency to the variable band filter 51. The zero weight ratio control unit 52 determines a variable zero weight ratio p (0≤p≤1) for controlling the number of non-zero weights W_{j,k} used in the product-sum calculation in the sub-reservoirs 12 in the reservoir layer 11, and outputs the determined variable zero weight ratio p to the weight generation unit 53.

The weight generation unit 53 is implemented by, for example, the processor 15. For example, the weight generation unit 53 randomly generates weights W_{1,0} to W_{63,0} to be multiplied by the reservoir input signal S_{IN}. The weight generation unit 53 generates the weights W_{j,k} for multiplying the output signals NR1 to NR63 of the respective reservoir neurons 20 such that a ratio of the number of zero weights W_{j,k} is the predetermined zero weight ratio p for each reservoir neuron 20 in the reservoir layer 11. Specifically, for example, after the weight generation unit 53 randomly generates the weights W_{j,k}, the weight generation unit 53 assigns random numbers uniformly distributed in a range of 0 to 1 to the respective weights W_{j,k}. Then, the weight generation unit 53 resets the weight W_{j,k} for which the assigned random number is p or less to zero, and adopts a randomly generated value for the weight W_{j,k} for which the assigned random number is larger than p.

For the weights W_{j,k} generated for the reservoir neurons 20 in this manner, the number of non-zero weights W_{j,k} is approximately 63*(1−p), and some variations in the number may occur. In the reservoir neurons 20 having a large number of the non-zero weights W_{j,k}, the weight generation unit 53 resets some of the non-zero weights W_{j,k} to zero to reduce the number of the non-zero weights W_{j,k}. On the other hand, in the reservoir neurons 20 having a small number of non-zero weights W_{j,k}, the number of the non-zero weights W_{j,k} is increased by resetting some of the zero weights W_{j,k} to have a non-zero value or performing a product-sum calculation while regarding the zero weights as non-zero weights.

The generated weights W_{j,k} are stored in the weight storage division memory 41 of the sub-reservoirs 12 in the reservoir layer 11. In this manner, read weights used for the read layer 13 are learned and applied in a state in which the numbers of the non-zero weights W_{j,k} supplied to the reservoir neurons 20 constituting each sub-reservoir 12 in the reservoir layer 11 are matched.

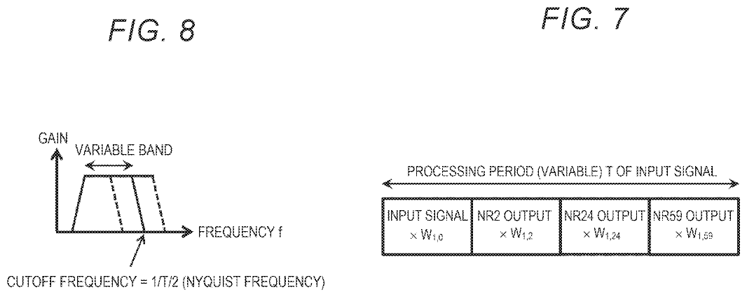

Next, FIG. 7 shows an example of a processing period in the sub-reservoir 12. As shown in FIG. 7, a period T in which the reservoir input signal S_{IN} can be processed in the sub-reservoir 12 is a product of a time of one cycle and the number of required cycles (four cycles in the example shown in FIG. 7). Since the number of required cycles is determined by the number of non-zero weights W_{j,k}, the number of required cycles is reduced as the zero weight ratio p increases. In the present embodiment, since the zero weight ratio p is variable, the number of required cycles is also variable. Accordingly, the processing period T of the reservoir input signal S_{IN} is also variable.

The processing period T of the reservoir input signal S_{IN} is also a period for sampling the reservoir input signal S_{IN}. According to a sampling theorem, it is known that a signal component having a frequency f exceeding 1/T/2 (Nyquist frequency) relative to a sampling period T is converted into a frequency (1/T−f) lower than the frequency f. Accordingly, when a signal component having a frequency f exceeding the Nyquist frequency is included in the reservoir input signal S_{IN}, the signal component having the frequency f is treated as a signal component having a lower frequency (1/T−f), and cannot be distinguished from a signal component having a frequency (1/T−f) that is originally present in the reservoir input signal S_{IN}. Therefore, the original signal component is impaired, which makes it difficult to detect a state of the equipment 100 with high sensitivity.

The zero weight ratio control unit 52 controls a passband of the variable band filter 51 based on setting of the zero weight ratio p for the weight generation unit 53. Specifically, the cutoff frequency on the high-frequency side is controlled.

FIG. 8 shows characteristics of the variable band filter 51, in which a horizontal axis represents a frequency of the reservoir input signal S_{IN} and a vertical axis represents a gain. As shown in FIG. 8, the zero weight ratio control unit 52 controls the cutoff frequency on the high-frequency side in the variable band filter 51 to a frequency the same as the Nyquist frequency.

As described above, since the Nyquist frequency is determined according to the setting of the zero weight ratio p, the cutoff frequency of the variable band filter 51 changes according to the setting of the zero weight ratio p. The cutoff frequency may not be the same frequency as the Nyquist frequency, may be a frequency higher or lower than the Nyquist frequency, and may be determined according to a mode of a time-series sensor signal output by the sensor 110. When the zero weight ratio p is high, the sampling period T is short, and thus the zero weight ratio control unit 52 sets the cutoff frequency of the variable band filter 51 to be high. On the other hand, when the zero weight ratio p is low, the zero weight ratio control unit 52 sets the cutoff frequency to be low.

As the zero weight ratio p increases, the reservoir computer 10₂ can process a signal component of a higher frequency included in the reservoir input signal (the time-series sensor signal) S_{IN}. However, when the zero weight ratio p is too high, a time required for calculation processing is long, and state detection capability is lowered. In the reservoir computer 10₂, the zero weight ratio control unit 52 sets an appropriate zero weight ratio p according to a task.

According to the reservoir computer 10₂, the same effect as the reservoir computer 10₁ (FIG. 1) can be obtained, and an appropriate zero weight ratio p can be set. Therefore, various tasks can be handled.

### Configuration Example of Reservoir Computer 10₃ According to Third Embodiment of Invention

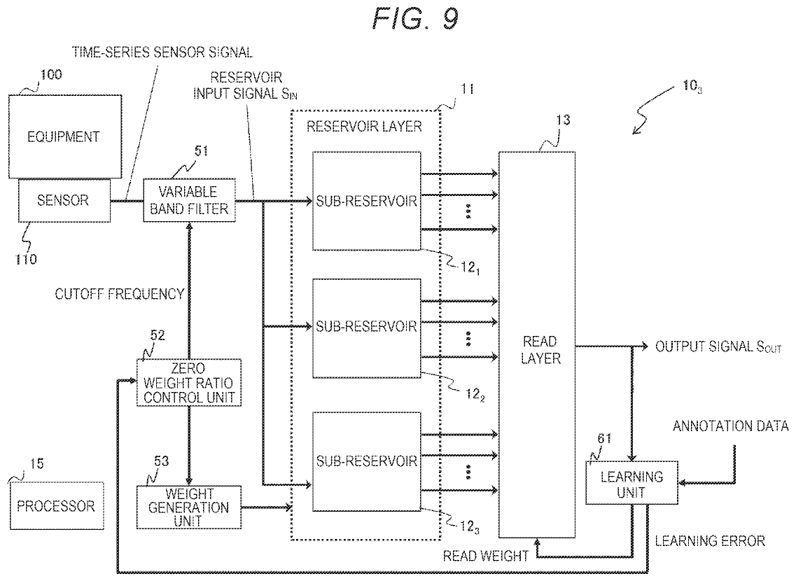

FIG. 9 shows a configuration example of a reservoir computer 10₃ based on an echo state network according to a third embodiment of the invention.

The reservoir computer 10₃ automatically searches for an appropriate zero weight ratio p in a learning period before an inference period (a period in which a state of the equipment 100 is detected by executing reservoir computing).

The reservoir computer 10₃ is obtained by adding a learning unit 61 to the reservoir computer 10₂ (FIG. 6). Components of the reservoir computer 10₃ other than the learning unit 61 are common to components of the reservoir computer 10₂, the common components are denoted by the same reference numerals, and description thereof will be omitted.

The learning unit 61 is implemented by, for example, the processor 15. The output signal S_{OUT} output from the read layer 13, annotation data (correct data) corresponding to the reservoir input signal S_{IN} for learning, and output signals NR (signal paths are not shown) from the sub-reservoirs 12 in the reservoir layer 11 are input to the learning unit 61. The learning unit 61 updates a read weight used for the product-sum calculation in the read layer 13 based on the output signal S_{OUT} from the read layer 13, the annotation data, and the output signals NR from the sub-reservoirs 12 in the reservoir layer 11. The learning unit 61 repeatedly updates the read weight until a difference between the output signal S_{OUT} and the annotation data is minimized. After the difference is minimized and updating of the read weight is completed, the learning unit 61 calculates a final minimum difference between the output signal S_{OUT} and the annotation data, and outputs the difference as a learning error to the zero weight ratio control unit 52.

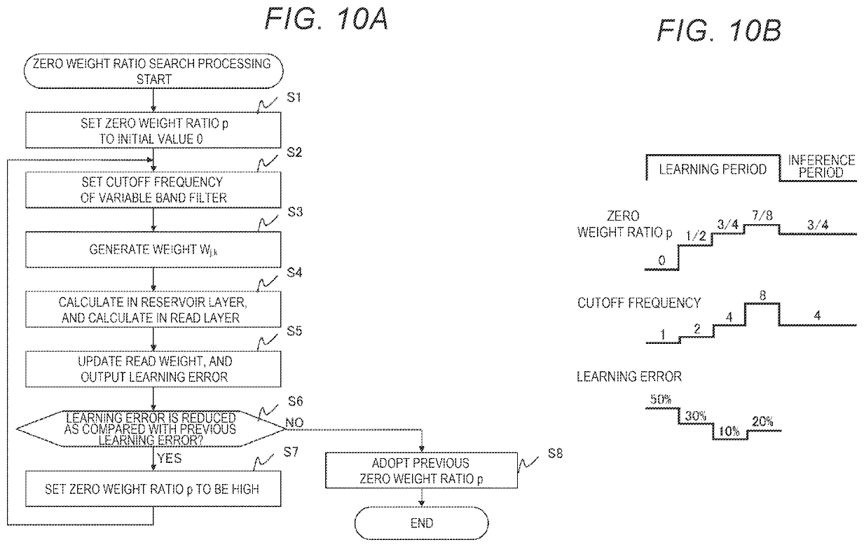

FIGS. 10A and 10B are diagrams showing zero weight ratio search processing executed by the reservoir computer 10₃, FIG. 10A is a flowchart showing an example of the zero weight ratio search processing, and FIG. 10B is a timing chart showing an example of the zero weight ratio search processing.

The zero weight ratio search processing is executed in a learning period before an inference period. First, the zero weight ratio control unit 52 sets the zero weight ratio p to an initial value of 0 and outputs the zero weight ratio p to the weight generation unit 53 (step S1). Next, similar to the reservoir computer 10₂, the zero weight ratio control unit 52 sets a cutoff frequency on a high-frequency side of the variable band filter 51 based on the zero weight ratio p and outputs the cutoff frequency to the variable band filter 51 (step S2).

Next, similar to the reservoir computer 10₂, the weight generation unit 53 generates the weight W_{j,k} and stores the weight W_{j,k} in the weight storage division memory 41. Next, the band-limited reservoir input signal S_{IN} for learning is input from the variable band filter 51 to the reservoir layer 11, and the reservoir neurons 20 constituting each sub-reservoir 12 in the reservoir layer 11 perform a calculation for one period and output the output signals NR which are calculation results to the read layer 13 and the learning unit 61. Then, the read layer 13 multiplies the output signals NR from the reservoir neurons 20 by read weights, performs integration, and outputs an integration result to the learning unit 61 as the output signal S_{OUT} (step S4).

Next, the learning unit 61 updates a read weight used for the product-sum calculation in the read layer 13 based on the output signal S_{OUT} from the read layer 13, the annotation data corresponding to the reservoir input signal S_{IN} for learning input to the reservoir layer 11, and the output signals NR from the reservoir layer 11. This updating is repeated until the difference between the output signal S_{OUT} and the annotation data is minimized. After updating of the read weight is completed, the learning unit 61 outputs a final minimum difference between the output signal S_{OUT} and the annotation data to the zero weight ratio control unit 52 as a learning error (step S5). In this case, for example, it is assumed that the learning error is 50% as shown in FIG. 10B.

Next, the zero weight ratio control unit 52 determines whether the learning error input from the learning unit 61 is reduced than a previously input learning error (step S6). Here, when there is no previous input learning error, or when it is determined that the learning error is reduced (YES in step S6), the zero weight ratio control unit 52 advances the processing to step S7. On the other hand, when it is determined that the learning error is not reduced (NO in step S6), the zero weight ratio control unit 52 adopts a previous zero weight ratio p (step S8).

In this case, since there is no previous input learning error, the processing proceeds to step S7. Next, the zero weight ratio control unit 52 sets the zero weight ratio p to be high (step S7). In this case, for example, it is assumed that the zero weight ratio p is set from 0 to ½ as shown in FIG. 10B. Thereafter, the processing is returned to step S2, and steps S2 to S6 are repeated a second time.

In the second-time step S2, for example, as shown in FIG. 10B, the zero weight ratio control unit 52 sets the cutoff frequency on the high-frequency side of the variable band filter 51 to twice the cutoff frequency set in the first-time step S2 based on the zero weight ratio p that is increased to ½, and outputs the cutoff frequency to the variable band filter 51. Thereafter, the second-time steps S3 to S5 are executed in the same manner as the first-time steps S3 to S5. In the second-time step S5, for example, it is assumed that the learning error is 30% as shown in FIG. 10B. In this case, in the second-time step S6, it is determined that the learning error is reduced as compared with a previous learning error, the processing proceeds to step S7, and the zero weight ratio p is set further higher. In this case, for example, it is assumed that the zero weight ratio p is set from ½ to ¾ as shown in FIG. 10B. Thereafter, the processing is returned to step S2, and steps S2 to S6 are repeated a third time.

In the third-time step S2, for example, as shown in FIG. 10B, the zero weight ratio control unit 52 sets the cutoff frequency on the high-frequency side of the variable band filter 51 to four times the cutoff frequency set in the first-time step S2 based on the zero weight ratio p that is increased to ¾, and outputs the cutoff frequency to the variable band filter 51. Thereafter, the third-time steps S3 to S5 are executed in the same manner as the first-time steps S3 to S5. In the third-time step S5, for example, it is assumed that the learning error is 10% as shown in FIG. 10B. In this case, in the third-time step S6, it is determined that the learning error is reduced as compared with a previous learning error, the processing proceeds to step S7, and the zero weight ratio p is set further higher. In this case, for example, it is assumed that the zero weight ratio p is set from ¾ to ⅞ as shown in FIG. 10B. Thereafter, the processing is returned to step S2, and steps S2 to S6 are repeated a fourth time.

In the fourth-time step S2, for example, as shown in FIG. 10B, the zero weight ratio control unit 52 sets the cutoff frequency on the high-frequency side of the variable band filter 51 to eight times the cutoff frequency set in the first-time step S2 based on the zero weight ratio p that is increased to ⅞, and outputs the cutoff frequency to the variable band filter 51. Thereafter, the fourth-time steps S3 to S5 are executed in the same manner as the first-time steps S3 to S5. In the fourth-time step S5, for example, it is assumed that the learning error is 20% as shown in FIG. 10B. In this case, in the fourth-time step S6, it is determined that the learning error is not reduced as compared with a previous learning error, the processing proceeds to step S8, and the previous zero weight ratio p (=¾) is adopted. Accordingly, values corresponding to the previous zero weight ratio p (=¾) are adopted for the cutoff frequency, the weight W_{j,k}, and the read weight. The zero weight ratio search processing is ended after the above steps, thereafter, the reservoir computer 10₃ can transition to the inference period, and a state of the equipment 100 can be detected with high accuracy.

### Configuration Example of Reservoir Computer 10₄ According to Fourth Embodiment of Invention

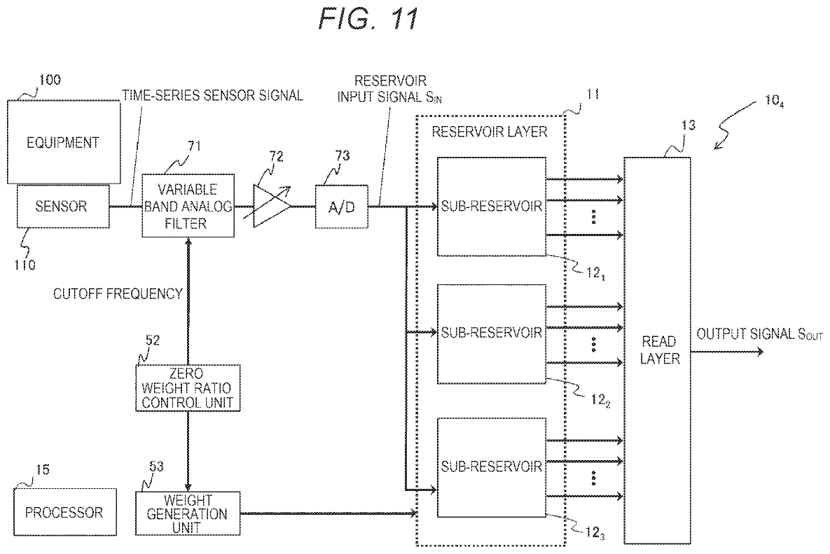

FIG. 11 shows a configuration example of a reservoir computer 10₄ based on an echo state network according to a fourth embodiment of the invention.

The reservoir computer 10₄ corresponds to a case where a time-series sensor signal from the sensor 110 is an analog signal.

In the reservoir computer 10₄, the variable band filter 51 of the reservoir computer 10₂ (FIG. 6) is replaced with a variable band analog filter 71, and a variable gain amplifier 72 and an analog-to-digital converter (A/D) 73 are added between the variable band analog filter 71 and the reservoir layer 11. Components of the reservoir computer 10₄ other than the variable band analog filter 71, the variable gain amplifier 72, and the A/D 73 are common to components of the reservoir computer 10₂, the common components are denoted by the same reference numerals, and description thereof will be omitted.

The variable band analog filter 71 limits a band of a time-series sensor signal, which is an analog signal from the sensor 110, according to a cutoff frequency on a high-frequency side received from the zero weight ratio control unit 52, and outputs the time-series sensor signal to the variable gain amplifier 72. The variable gain amplifier 72 amplifies the band-limited time-series sensor signal with an appropriate gain and outputs the amplified time-series sensor signal to the A/D 73. The A/D 73 converts the amplified time-series sensor signal into a digital signal and outputs the digital signal to the reservoir layer 11 as the reservoir input signal S_{IN}.

According to the reservoir computer 10₄, the same effects as the reservoir computer 10₂ can be obtained. Further, unnecessary components included in the time-series sensor signal from the sensor 110 can be further attenuated by the variable band analog filter 71, and necessary components can be further amplified by the variable gain amplifier 72. As a result, a conversion error (that is, a quantization error, a thermal noise, a distortion, or the like) in the A/D 73 and a calculation error in the reservoir computer 10₄ hardly affect state detection, and the state detection can be performed with high sensitivity.

### Implementation of Selector 21 Using FPGA

As described above, in the reservoir computers 10₁ to 10₄, each reservoir neuron 20 requires one selector 21. Therefore, when the selector can be implemented efficiently, usability of the invention can be further enhanced. Hereinafter, a method of implementing the selector 21 when the reservoir computers 10₁ to 10₄ are implemented on an FPGA will be described.

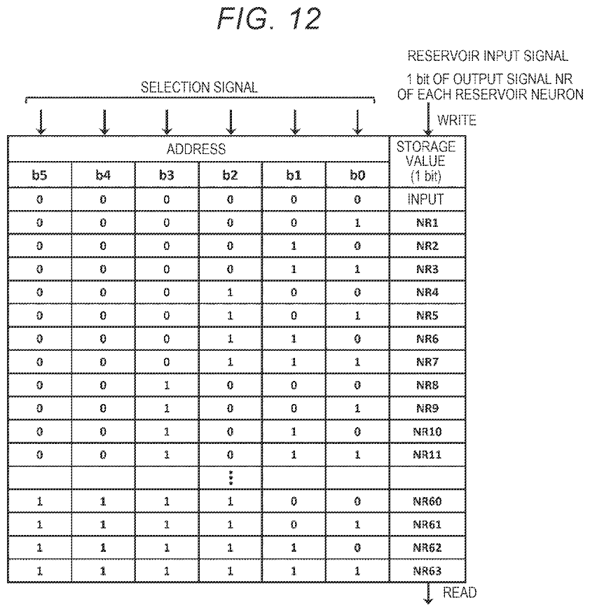

It is known that an FPGA can use a 6-input LUT that is a component of the FPGA as a memory (a distributed memory). FIG. 12 shows a method of implementing the selector by using the 6-input LUT as a temporary memory.

The 6-input LUT used as a temporary memory can store 64 1-bit values (0 or 1), and any one of the 64 1-bit values, that is, 0th to 63rd values can be read by specifying a 6-bit address signal. In the present embodiment, the reservoir input signal S_{IN} and the output signal NR of each of the reservoir neurons 20 are stored in the 6-input LUT by one bit each and then the signals are read using address signals of the 6-input LUT, thereby implementing an operation of the selector 21.

Therefore, the selection signals 1 to 63 for the selectors 21 in the 63 reservoir neurons 20 constituting the sub-reservoir 12 are input to the 6-input LUT as 6-bit address signals as shown in FIG. 12. Corresponding to a value of a selection signal shown in FIG. 5, (one bit of) the reservoir input signal S_{IN} is stored at a 0th address, and (one bit of) the output signals NR1 to NR63 from the 63 reservoir neurons 20 are stored at 1st to 63rd addresses.

However, since one 6-input LUT can store only one bit of each signal as shown in FIG. 12, in order to actually implement the selector 21, it is required to operate, in parallel, 6-input LUTs of the same number as the bit number N of signals input to the selector 21.

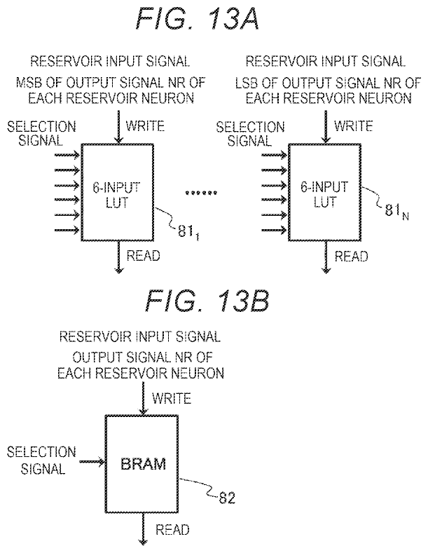

FIG. 13A shows a configuration example in a case where the selector 21 is implemented by operating, in parallel, 6-input LUTs 81₁ to 81_{N} of the same number N as the bit number N of signals input to the selector 21.

The 6-input LUT 81₁ stores the reservoir input signal S_{IN} and an upmost bit of the output signals NR1 to NR63 from the reservoir neurons 20. Similarly, the 6-input LUT 81₂ and subsequent 6-input LUTs (not shown) store the reservoir input signal S_{IN} and one bit on an upmost side of the output signals NR1 to NR63 from the reservoir neurons 20. The last 6-input LUT 81_{N} stores the reservoir input signal S_{IN} and a lowest bit of the output signals NR1 to NR63 from the reservoir neurons 20.

A total of N-bit signals can be simultaneously read from the 6-input LUTs 81₁ to 81_{N} by inputting a common 6-bit address signal to the N 6-input LUTs 81₁ to 81_{N}, and an operation of the selector 21 can be implemented.

Next, FIG. 13B shows a configuration example in which the selector 21 is implemented by operating a BRAM 82 provided by an FPGA.

Since the BRAM 82 is a memory, the reservoir input signal S_{IN} and the output signals NR1 to NR63 of the reservoir neurons 20 are written into the BRAM 82 and then the signals are read according to a selection signal, thereby implementing an operation of the selector 21, in a similar manner to the N 6-input LUTs 81₁ to 81_{N} shown in FIG. 13A. Since one BRAM 82 is used to implement one selector 21, BRAMs 82 of the same number as the total number of the reservoir neurons 20 provided in the reservoir layer 11 are required.

In general, a storage capacity per BRAM is larger than a storage capacity required for an operation of the selector 21 (that is, a capacity for storing the reservoir input signal S_{IN} and the output signals NR1 to NR63 from the reservoir neurons 20 in the case of FIG. 2). Accordingly, a selector using the BRAM is inefficiently implemented as compared with a case where a 6-input LUT is used as a temporary memory. On the other hand, when a resource of the 6-input LUT of the FPGA is insufficient, a method using the BRAM is useful since it is not necessary to use the resource of the 6-input LUT.

As described when the selector 21 is implemented using the 6-input LUT of the FPGA or the BRAM, a large number of required selectors 21 can be efficiently implemented. Accordingly, the reservoir computers 10₁ to 10₄ can be implemented on a low-cost FPGA having limited hardware resources. Therefore, a processing speed (that is, a frequency of processing a reservoir input signal) of each of the reservoir computers 10₁ to 10₄ can be significantly improved. Accordingly, it is possible to process a time-series sensor signal output from the sensor 110 up to a high-frequency component, and as a result, it is possible to detect a state with high sensitivity.

The invention is not limited to the embodiments described above, and various modifications can be made. For example, the embodiments described above have been described in detail to facilitate understanding of the invention, and the invention is not necessarily limited to those including all the configurations described above. In addition, a part of configurations of an embodiment may be replaced with or added to configurations of another embodiment.

Some or all of the above-described configurations, functions, processing units, processing methods, and the like may be implemented by hardware, for example, by designing an integrated circuit. The above-described configurations, functions, and the like may be implemented by software when a processor interprets and executes a program for implementing functions. Information such as a program, a table, and a file for implementing a function can be stored in a recording device such as a memory, a hard disk, and an SSD, or a recording medium such as an IC card, an SD card, and a DVD. Control lines and information lines are considered to be necessary for description, and all of the control lines and information lines are not necessarily shown in a product. Actually, almost all components may be considered to be connected to one another.

What is claimed is:

1. A reservoir computer based on an echo state network, the reservoir computer comprising:
a reservoir layer configured to receive a time-series signal as a reservoir input signal; and
a read layer, wherein
the reservoir layer is divided into a plurality of sub-reservoirs,
each of the sub-reservoirs includes a plurality of reservoir neurons,
each of the reservoir neurons includes the following units arranged in this order:
a selector configured to sequentially select one of the reservoir input signal and output signals from the plurality of reservoir neurons,
a multiplier configured to multiply a selection result of the selector by a weight,
an integrator configured to integrate multiplication results of the multiplier, and
an activation function calculator configured to calculate an output value of an activation function in which an integration result of the integrator is set as an input,
the selector sequentially selects, according to a selection signal, one of the reservoir input signal and the output signals from the reservoir neurons each of which is multiplied by a non-zero weight in the multiplier, and
the read layer performs a product-sum calculation using a read weight on the output signals from the plurality of reservoir neurons included in each of the plurality of sub-reservoirs, and outputs a calculation result as an output signal from the reservoir computer.

2. The reservoir computer according to claim 1, further comprising:
a memory configured to store a selection number serving as the selection signal and the non-zero weight in association with each other; and
a processor, wherein
the processor reads the selection number from the memory and supplies the selection number to the selector, and reads the non-zero weight and supplies the weight to the multiplier.

3. The reservoir computer according to claim 1, further comprising:
a variable band filter provided in a stage before the reservoir layer and configured to limit a band of the reservoir input signal; and
a processor, wherein
the processor controls a zero weight ratio indicating a ratio of the non-zero weight supplied to the multiplier, and controls a passband of the variable band filter according to the zero weight ratio.

4. The reservoir computer according to claim 3, wherein
during a learning period, the processor learns the weight read in the read layer based on the output signals output from the plurality of reservoir neurons based on the reservoir input signal for learning, the output signal calculated by the read layer, and annotation data corresponding to the reservoir input signal for learning, calculates a learning error, and updates the zero weight ratio based on the learning error.

5. The reservoir computer according to claim 3, further comprising:
a variable gain amplifier and an analog-to-digital converter that are provided between the variable band filter and the reservoir layer, wherein
the variable gain amplifier amplifies the reservoir input signal attenuated by the variable band filter, and
the analog-to-digital converter converts the reservoir input signal amplified by the variable gain amplifier into a digital signal.

6. The reservoir computer according to claim 1, wherein
the selector sequentially selects, among the reservoir input signal and the output signals from the plurality of reservoir neurons belonging to the same sub-reservoir, one of the output signals multiplied by the non-zero weight in the multiplier.

7. The reservoir computer according to claim 1, wherein
the selector is implemented by a look up table in a field programmable gate array (FPGA), and
the reservoir input signal and the output signals from the plurality of reservoir neurons are written into the look up table, and the selection signal for the selector is supplied as an address signal for reading the look up table.

8. The reservoir computer according to claim 1, wherein
the selector is implemented by a Block RAM in an FPGA, and
the reservoir input signal and the output signals from the plurality of reservoir neurons are written into the Block RAM, and the selection signal for the selector is supplied as an address signal for reading the Block RAM.

9. An equipment state detection system comprising:
an equipment;
a sensor disposed in the equipment or in the vicinity of the equipment; and
a reservoir computer based on an echo state network, wherein
the reservoir computer includes
a reservoir layer configured to receive, as a reservoir input signal, a time-series sensor signal input from the sensor, and
a read layer,
the reservoir layer is divided into a plurality of sub-reservoirs,
each of the sub-reservoirs includes a plurality of reservoir neurons,
each of the reservoir neurons includes the following units arranged in this order:
a selector configured to sequentially select one of the reservoir input signal and output signals from the plurality of reservoir neurons,
a multiplier configured to multiply a selection result of the selector by a weight,
an integrator configured to integrate multiplication results of the multiplier, and
an activation function calculator configured to calculate an output value of an activation function in which an integration result of the integrator is set as an input,
the selector sequentially selects, according to a selection signal, one of the reservoir input signal and the output signals from the reservoir neurons each of which is multiplied by a non-zero weight in the multiplier, and
the read layer performs a product-sum calculation using a read weight on the output signals from the plurality of reservoir neurons included in each of the plurality of sub-reservoirs, and outputs a calculation result as an output signal from the reservoir computer indicating a state of the equipment.
